(19) United States
(12) Patent Application Publication
(10) Pub. No.: US 2026/0221625 A1
(43) Pub. Date: Jul. 30, 2026

(54) ALL-SOLID-STATE BATTERY AND ELECTRONIC DEVICE

(71) Applicant: TDK CORPORATION, Tokyo (JP)

(72) Inventors: Masayuki MUROI, Tokyo (JP); Hisaji OYAKE, Tokyo (JP); Teiichi TANAKA, Tokyo (JP)

(73) Assignee: TDK CORPORATION, Tokyo (JP)

(21) Appl. No.: 19/141,595

(22) PCT Filed: Dec. 22, 2023
(86) PCT No.: PCT/JP2023/046179

§ 371 Date: Jun. 20, 2025

(30) Foreign Application Priority Data
Dec. 22, 2022 (JP) 2022-205361

(51) Int. Cl. H01M 50/562

(52) U.S. Cl. CPC H01M 50/562

(57) ABSTRACT

An all-solid-state battery which includes: a battery element; a positive electrode terminal; and a negative electrode terminal. The battery element has a positive and negative electrode, and solid electrolyte layer between positive and negative electrode. Positive electrode terminal is connected to positive electrode on first surface of battery element. Negative electrode terminal is connected to negative electrode on second surface different from first surface of battery element. Negative electrode includes a material that forms alloy with Li. Negative electrode terminal has a main portion including material that forms alloy with Li and coating layer covering at least a part of outer surface of main portion. At least a part of a mounting surface of the negative electrode terminal is the coating layer. The coating layer includes at least one selected from the group consisting of W, Ti, Ni, Cr, Mn, Fe, Cu, and Co.

### TECHNICAL FIELD

The present invention relates to an all-solid-state battery and an electronic device.

Priority is claimed on Japanese Patent Application No. 2022-205361, filed Dec. 22, 2022, the content of which is incorporated herein by reference.

### BACKGROUND ART

In recent years, the development of electronics technology has been remarkable, and portable electronic devices have been made smaller, lighter, thinner, and multifunctional. Accordingly, there is a strong demand for batteries that serve as power sources for electronic devices to be smaller, lighter, thinner, and more reliable, and all-solid-state batteries that use a solid electrolyte as an electrolyte have been attracting attention.

An all-solid-state battery performs charging and discharging by movement of lithium ions between a positive electrode and a negative electrode through a solid electrolyte. Lithium ions, when reacting with other metals, may combine to form an alloy or may not form an alloy. For example, Patent Document 1 discloses a lithium-ion secondary battery including a metal that forms an alloy with lithium and a metal that does not form an alloy with lithium. Whether lithium forms an alloy with a metal can be confirmed using a phase diagram.

### CITATION LIST

### Patent Document

Patent Document 1: Japanese Patent No. 5156195

### SUMMARY OF INVENTION

### Technical Problem

An all-solid-state battery includes a battery element and a positive electrode terminal and a negative electrode terminal for extracting electricity generated by the battery element to the outside. The positive electrode terminal and the negative electrode terminal of the all-solid-state battery are mounted on a printed circuit board or the like. Insufficient joining between the all-solid-state battery and the printed circuit board may cause mounting defects in some cases.

The present invention has been made in view of the above-described problem, and an object of the present invention is to provide an all-solid-state battery in which mounting defects are less likely to occur.

### Solution to Problem

The present invention provides the following means to solve the above-described problem.

(1) An all-solid-state battery according to a first aspect includes: a battery element; a positive electrode terminal; and a negative electrode terminal. The battery element has a positive electrode, a negative electrode, and a solid electrolyte layer between the positive electrode and the negative electrode. The positive electrode terminal is connected to the positive electrode on a first surface of the battery element. The negative electrode terminal is connected to the negative electrode on a second surface different from the first surface of the battery element. The negative electrode includes a material that forms an alloy with Li. The negative electrode terminal has a main portion including a material that forms an alloy with Li and a coating layer covering at least a part of an outer surface of the main portion. At least a part of a mounting surface of the negative electrode terminal is the coating layer. The coating layer includes at least one selected from the group consisting of W, Ti, Ni, Cr, Mn, Fe, Cu, and Co.

(2) In the all-solid-state battery according to the above-described aspect, the entire mounting surface of the negative electrode terminal may be the coating layer.

(3) In the all-solid-state battery according to the above-described aspect, a first end of the main portion on a side closer to the mounting surface may be covered by the coating layer.

(4) In the all-solid-state battery according to the above-described aspect, the coating layer may cover 75% or more of the outer surface of the main portion.

(5) In the all-solid-state battery according to the above-described aspect, an average thickness of the coating layer may be 0.1 μm to 100 μm.

(6) In the all-solid-state battery according to the above-described aspect, an average thickness of the coating layer may be thinner than an average thickness of the main portion.

(7) In the all-solid-state battery according to the above-described aspect, the positive electrode terminal may include a main portion connected to the positive electrode and a coating layer covering at least a part of an outer surface of the main portion of the positive electrode terminal and including at least one selected from the group consisting of W, Ti, Ni, Cr, Mn, Fe, Cu, and Co.

(8) In the all-solid-state battery according to the above-described aspect, the negative electrode and the negative electrode terminal may include Ag.

(9) An electronic device according to a second aspect has the all-solid-state battery according to the above-described aspect mounted thereon.

### Advantageous Effects of Invention

The all-solid-state battery and the electronic device according to the above-described aspects are less likely to cause mounting defects.

### BRIEF DESCRIPTION OF DRAWINGS

FIG. 1 is a cross-sectional view of an electronic device according to a first embodiment.

FIG. 2 is an enlarged cross-sectional view of a characteristic portion of an all-solid-state battery according to the first embodiment.

FIG. 3 is an enlarged cross-sectional view of a part of the electronic device according to the first embodiment.

FIG. 4 is an enlarged cross-sectional view of another part of the electronic device according to the first embodiment.

### DESCRIPTION OF EMBODIMENT

Hereinafter, the present embodiment will be described in detail with reference to the accompanying drawing as appropriate. In the drawings used in the following description, a part that becomes a feature of the present invention is sometimes enlarged for convenience in order to allow the feature to be easily understood, and the dimensional ratios of each constituent element and the like are sometimes different from the actual ones. The materials, dimensions, and the like exemplified in the following description are merely examples, and the present invention is not limited thereto and can be implemented by being appropriately modified within the range that does not change the gist thereof.

Directions will be defined. The lamination direction of a battery element 4 is designated as the z-direction, one direction in a plane orthogonal to the z-direction is designated as the x-direction, and a direction orthogonal to both the x-direction and the z-direction is designated as the y-direction. Hereinafter, one direction in the z-direction may be referred to as “up,” and a direction opposite to this direction may be referred to as “down.” Up and down do not necessarily match the direction in which gravity is applied.

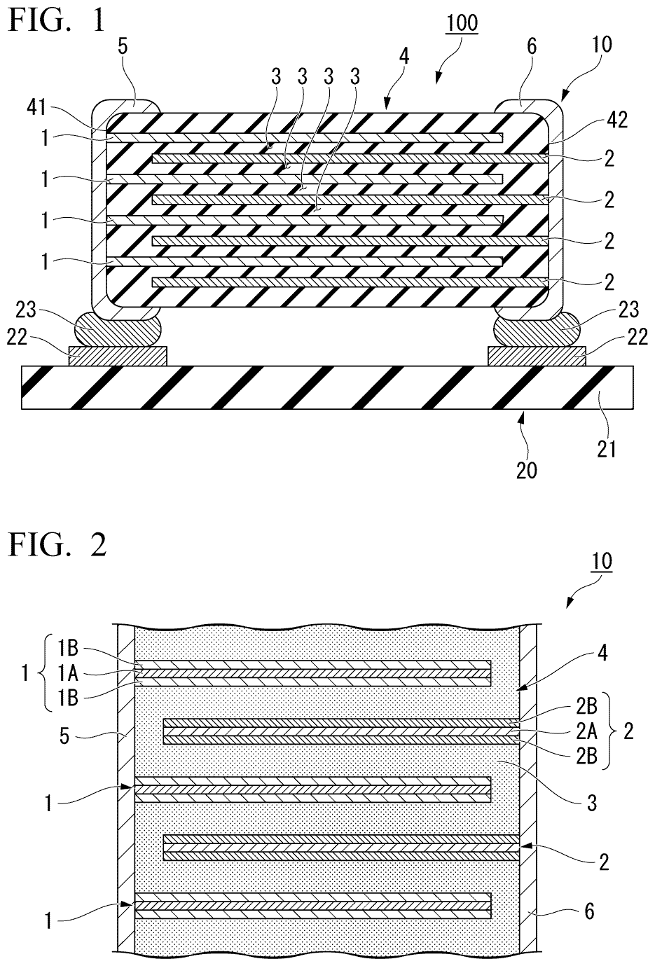

FIG. 1 is a cross-sectional view of an electronic device 100 according to a first embodiment. The electronic device 100 includes an all-solid-state battery 10 and a printed circuit board 20. The all-solid-state battery 10 is mounted on the printed circuit board 20.

(Printed Circuit Board) The printed circuit board 20 includes, for example, a substrate 21, a pad 22, and a connection portion 23. The all-solid-state battery 10 is connected to the pad 22 of the substrate 21 via the connection portion 23. The connection portion 23 is, for example, solder.
(All-Solid-State Battery) The all-solid-state battery 10 includes a battery element 4, a positive electrode terminal 5, and a negative electrode terminal 6. The all-solid-state battery 10 is, for example, a laminated battery, a prismatic battery, a cylindrical battery, a coin battery, and a button battery. The all-solid-state battery 10 may be an injection type in which a solid electrolyte layer 3 is dissolved or dispersed in a solvent.

### <Battery Element>

The battery element 4 includes a positive electrode 1, a negative electrode 2, and the solid electrolyte layer 3. The battery element 4 performs charging or discharging by the transfer of ions between the positive electrode 1 and the negative electrode 2 via the solid electrolyte layer 3. The battery element 4 is, for example, a laminated body in which the positive electrode 1, the negative electrode 2, and the solid electrolyte layer 3 are laminated. The battery element 4 may also be, for example, a wound body in which the laminated body in which the positive electrode 1, the negative electrode 2, and the solid electrolyte layer 3 are laminated is wound.

The number of layers of the positive electrode 1 and the negative electrode 2 in the battery element 4 is not limited. A first end of the positive electrode 1 is connected to the positive electrode terminal 5 on a first surface 41 of the battery element 4. A first end of the negative electrode 2 is connected to the negative electrode terminal 6 on a second surface 42 of the battery element 4. The first surface 41 and the second surface 42 are different surfaces of the battery element 4. For example, the first surface 41 and the second surface 42 are opposite to each other.

The solid electrolyte layer 3 is disposed between the positive electrode 1 and the negative electrode 2. Within a layer in which the positive electrode 1 is laminated, a solid electrolyte, for example, the same as that of the solid electrolyte layer 3, is present between the positive electrode 1 and the negative electrode terminal 6. In addition, within a layer in which the negative electrode 2 is laminated, a solid electrolyte, for example, the same as that of the solid electrolyte layer 3, is present between the negative electrode 2 and the positive electrode terminal 5.

“Positive Electrode” FIG. 2 is an enlarged view of a characteristic portion of the all-solid-state battery 10 according to the first embodiment. The positive electrode 1 may be composed of a single layer or multiple layers. Each positive electrode 1 extends in a direction intersecting the z-direction. The positive electrode 1 includes, for example, a positive electrode current collector layer 1A and positive electrode active material layers 1B.

The positive electrode current collector layer 1A includes, for example, a material with high conductivity. The positive electrode current collector layer 1A is made of, for example, a metal or alloy containing at least one metal element of silver (Ag), palladium (Pd), gold (Au), platinum (Pt), aluminum (Al), copper (Cu), and nickel (Ni). In addition, the positive electrode current collector layer 1A may be made of a non-metal such as carbon (C) as long as it has conductivity. The positive electrode current collector layer 1A is made of, for example, Ag or an AgPd alloy.

The positive electrode active material layer 1B is formed on one side or both sides of the positive electrode current collector layer 1A. The positive electrode active material layer 1B includes a positive electrode active material. The positive electrode active material layer 1B may also include a conductive additive, a binder, and a solid electrolyte described below.

The positive electrode active material is, for example, a transition metal oxide or a transition metal composite oxide. The positive electrode active material is, specifically for example, lithium-manganese composite oxide Li₂MnₐMa₁₋ₐO₃ (0.8≤a≤1, Ma=Co, Ni), lithium cobalt oxide (LiCoO₂), lithium nickel oxide (LiNiO₂), lithium manganese oxide (LiMn₂O₄) having a spinel structure, composite metal oxide represented by the general formula LiNiₓCo_{y}Mn_{z}O₂(x+y+z=1, 0≤x≤1, 0≤y≤1, 0≤z≤1), lithium vanadium compound (LiV₂O₅), olivine type LiMbPO₄ in which Mb is one or more kinds of elements selected from Co, Ni, Mn, Fe, Mg, Nb, Ti, Al, and Zr, lithium vanadium phosphate (Li₃V₂(PO₄)₃ or LiVOPO₄), Li-excess solid solution positive electrode represented by Li₂MnO₃—LiMcO₂ (Mc=Mn, Co, Ni), lithium titanate (Li₄Ti₅O₁₂), titanium oxide (TiO₂), and composite metal oxide represented by LiₛNiₜCoᵤAlᵥO₂ (0.9<s<1.3, 0.9<t+u+v<1.1).

In addition, these positive electrode active materials may have a part of each element substituted with a different element or may vary from the stoichiometric composition.

The conductive additive is not particularly limited as long as it improves the electronic conductivity within the positive electrode active material layer 1, and a known conductive additive can be used. Examples of the conductive additive include carbon-based materials such as graphite, carbon black, graphene, and carbon nanotubes, metals such as gold, platinum, silver, palladium, aluminum, copper, nickel, stainless steel, and iron, conductive oxides such as ITO, or mixtures thereof. The conductive additive may be in the form of powder or fibers.

The binder joins the positive electrode current collector layer 1A and the positive electrode active material layer 1i, the positive electrode active material layer 1B and the solid electrolyte layer 3, and the various materials constituting the positive electrode active material layer 1B together.

The binder can be used within a range that does not impair the function of the positive electrode active material layer 1B. The binder may not be included if it is not necessary. The content of the binder in the positive electrode active material layer 1B is, for example, 0.5 to 30 volume % of the positive electrode active material layer. When the content of the binder is sufficiently low, the resistance of the positive electrode active material layer 1B becomes sufficiently low (the lower the content of the binder, the lower the resistance of the positive electrode active material layer 1). Here, the volume % is, for example, approximately consistent with the area % measured in a cross-section by a scanning electron microscope. Therefore, the area ratio measured in a cross-section by a scanning electron microscope can be regarded as the volume ratio as it is.

The binder may be any material capable of the above-described joining, and may be, for example, a fluororesin such as polyvinylidene fluoride (PVDF) or polytetrafluoroethylene (PTFE). In addition, the binder may be, for example, cellulose, styrene-butadiene rubber, ethylene-propylene rubber, a polyimide resin, or a polyamide-imide resin. In addition, as the binder, a conductive polymer having electronic conductivity or an ion-conductive polymer having ionic conductivity may be used. The conductive polymer having electronic conductivity is, for example, polyacetylene. The ion-conductive polymer having ionic conductivity is, for example, a composite of a monomer of a polymer compound and a lithium salt or an alkali metal salt mainly composed of lithium. In this case, the polymer compound is, for example, a polyether-based polymer compound such as polyethylene oxide or polypropylene oxide, or polyphosphazene. In this case, the lithium salt is, for example, LiClO₄, LiBF₄, or LiPF₆.

### “Negative Electrode”

The negative electrode 2 may be composed of a single layer or multiple layers. Each negative electrode 2 extends in a direction intersecting the z-direction. The negative electrode 2 includes, for example, a negative electrode current collector layer 2A and a negative electrode active material layer 2B.

The negative electrode 2 includes, for example, a material that forms an alloy with Li. The material that forms an alloy with Li may be contained in either the negative electrode current collector layer 2A or the negative electrode active material layer 2B. The material that forms an alloy with Li is, for example, Ag. The negative electrode 2 includes, for example, Ag or an Ag alloy. When the negative electrode 2 includes a material that forms an alloy with Li, the transfer of lithium ions in the negative electrode 2 becomes smooth.

The negative electrode current collector layer 2A includes, for example, a material with high conductivity. For example, a material similar to that of the positive electrode current collector layer 1A may be used for the negative electrode current collector layer 2A. The negative electrode current collector layer 2A is, for example, Ag or an AgPd alloy.

The negative electrode active material layer 2B is formed on one side or both sides of the negative electrode current collector layer 2A. The negative electrode active material layer 2B includes a negative electrode active material. The negative electrode active material layer 2B may also include a conductive additive, a binder, and a solid electrolyte described below.

The negative electrode active material is a compound capable of occluding and releasing ions. The negative electrode active material is a compound exhibiting a lower potential than that of the positive electrode active material. The negative electrode active material is, for example, Li₄Ti₅O₁₂, Li₂TiO₃, Li₂TiSiO₅, or a mixture thereof.

The conductive additive improves the electronic conductivity of the negative electrode active material layer 2B. A material similar to that of the positive electrode active material layer 1B may be used for the conductive additive.

The binder joins the negative electrode current collector layer 2A and the negative electrode active material layer 2B, the negative electrode active material layer 2B and the solid electrolyte layer 3, and the various materials constituting the negative electrode active material layer 2B together. A material similar to that of the positive electrode active material layer 1B may be used for the binder. The content ratio of the binder may also be the same as that of the positive electrode active material layer 1B. The binder may not be included if it is not necessary.

FIG. 2 shows an example where the negative electrode 2 consists of the negative electrode current collector layer 2A and the negative electrode active material layers 2B, but the present invention is not limited to this case. For example, the negative electrode 2 may be composed of a single layer in which a negative electrode current collector and a negative electrode active material are mixed.

### “Solid Electrolyte Layer”

The solid electrolyte layer 3 is located between the adjacent positive electrode 1 and negative electrode 2. The solid electrolyte layer 3 includes a solid electrolyte. The solid electrolyte is a substance capable of moving ions under an externally applied electric field. For example, the solid electrolyte layer 3 conducts lithium ions and inhibits the movement of electrons. The solid electrolyte layer 3 is, for example, a sintered body obtained by sintering.

As the solid electrolyte layer 3, it is preferable to use a substance with low electronic conductivity and high lithium ion conductivity. For example, the solid electrolyte layer 3 is a perovskite-type compound such as La_{0.5}Li_{0.5}TiO₃, a LISICON-type compound such as Li₁₄Zn(GeO₄)₄, a garnet-type compound such as Li₇La₃Zr₂O₁₂, a NASICON-type compound such as LiZr₂(PO₄)₃, L_{1.3}Al_{0.3}Ti_{1.7}(PO₄)₃, or Li_{1.5}Al_{0.5}Ge_{1.5}(PO₄)₃, a thio-LISICON-type compound such as Li_{3.25}Ge_{0.25}P_{0.75}S₄ or Li₃PS₄, a glass compound such as Li₂S—P₂S₅ or Li₂O—V₂O₅—SiO₂, and phosphate compound such as Li₃PO₄, L_{3.5}Si_{0.5}P_{0.5}O₄, or Li_{2.9}PO_{3.3}N_{0.46}.

The solid electrolyte layer 3 includes, for example, a solid electrolyte having a γ-Li₃PO₄-type crystal structure. The solid electrolyte having a γ-Li₃PO₄-type crystal structure exhibits excellent ionic conductivity. The solid electrolyte is, for example, Li₃₊ₓSiₓP₁₋ₓO₄, Li₃₊ₓSiₓV₁₋ₓO₄, Li₃₊ₓGeₓP₁₋ₓO₄, Li₃₊ₓGeₓV₁₋ₓO₄, or the like, and preferably Li₃₊ₓSiₓP₁₋ₓO₄. The value of x satisfies 0.4≤x≤0.8. In addition, the solid electrolyte may also be a ternary lithium oxide containing Si, V, Ge, and the like.

### <Negative Electrode Terminal>

The negative electrode terminal 6 is in contact with the second surface 42 of the battery element 4. The negative electrode terminal 6 covers the second surface 42 of the battery element 4. A part of the negative electrode terminal 6 may extend around to a surface adjacent to the second surface 42 (for example, the upper and lower surfaces of the battery element 4 in FIG. 1). The negative electrode terminal 6 is responsible for the electrical conduction between the battery element 4 and the pad 22.

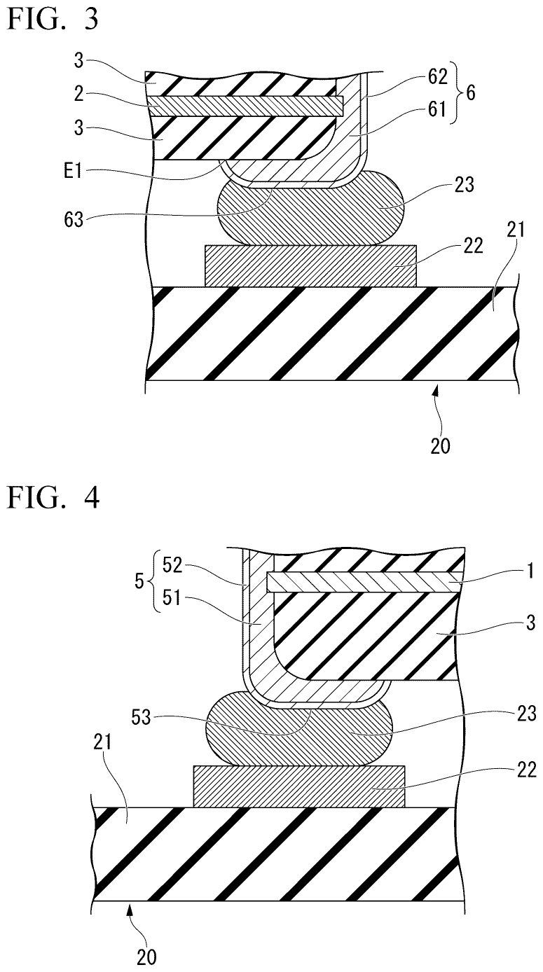

FIG. 3 is an enlarged cross-sectional view of a part of the electronic device according to the first embodiment. FIG. 3 is an enlarged view of the vicinity of the contact point between the negative electrode terminal 6 and the connection portion 23. The negative electrode terminal 6 includes, for example, a main portion 61 and a coating layer 62.

The main portion 61 is a portion that is in contact with the second surface 42 of the battery element 4. The main portion 61 is in contact with the negative electrode 2 of the battery element 4. The main portion 61 includes a material that forms an alloy with Li. The adhesion between the main portion 61 and the negative electrode 2 is enhanced by the main portion 61 including the same material as that contained in the negative electrode 2.

The coating layer 62 covers at least a part of the outer surface of the main portion 61. The coating layer 62 preferably covers 75% or more of the outer surface of the main portion 61, and more preferably covers 80% or more. That is, the area of the portion of the outer surface of the main portion 61 covered by the coating layer 62 is preferably 75% or more of the total area of the outer surface of the main portion 61, and more preferably 80% or more.

The coating layer 62 covers, for example, at least the surface of the main portion 61 near the connection portion 23. Therefore, at least a part of a mounting surface 63 of the negative electrode terminal 6 is the coating layer 62. The mounting surface 63 is the surface of the negative electrode terminal 6 that is in contact with the connection portion 23. It is preferable that the entire mounting surface 63 of the negative electrode terminal 6 be the coating layer 62.

The coating layer 62 includes, for example, at least one selected from the group consisting of W, Ti, Ni, Cr, Mn, Fe, Cu, and Co. These elements do not form an alloy with Li. When the coating layer 62, which includes elements that do not form an alloy with Li, is formed on the mounting surface 63, the precipitation of lithium compounds on the mounting surface 63 can be suppressed. Lithium compounds are formed when lithium ions move to the outer surface through the negative electrode 2 and the negative electrode terminal 6 during charging and discharging of the all-solid-state battery 10 and react with other metals. Since the negative electrode 2 and the negative electrode terminal 6 include materials that form an alloy with Li, lithium ions can move internally. When lithium compounds precipitate on the mounting surface 63, the connection between the negative electrode terminal 6 and the connection portion 23 weakens. In other words, when the negative electrode terminal 6 has the coating layer 62, connection defects between the negative electrode terminal 6 and the connection portion 23 are less likely to occur. Even when the coating layer 62 covers a part of the mounting surface 63, the connection between the negative electrode terminal 6 and the connection portion 23 is stronger compared to when the mounting surface 63 has no coating layer 62.

The average thickness of the coating layer 62 is, for example, 0.1 μm to 100 μm. When the thickness of the coating layer 62 is sufficiently thick, the precipitation of lithium compounds on the mounting surface 63 can be prevented. In addition, the average thickness of the coating layer 62 is thinner than the average thickness of the main portion 61. When the main portion 61 is sufficiently thick, sufficient adhesion between the main portion 61 and the negative electrode 2 can be ensured. The average thickness is the average value of thicknesses measured by cross-sectional observation at ten different locations. The cross-sectional observation can be performed, for example, using a scanning electron microscope or the like.

In addition, a first end E1 of the main portion 61, which is close to the mounting surface 63, is preferably covered with the coating layer 62. The first end E1 is the end portion on the mounting surface 63 side in the z-direction of the negative electrode terminal 6 and is located farthest from the second surface 42 of the portion of the negative electrode terminal 6 that is wrapped around the lower surface of the battery element 4. The first end E1 may be a point or an edge. When the first end E1 is covered with the coating layer 62, the precipitation of lithium compounds from the first end E1 can be prevented. Since the first end E1 is located near the mounting surface 63, if lithium compounds precipitate in the vicinity of the first end E1, they may reach the mounting surface 63.

### <Positive Electrode Terminal>

The positive electrode terminal 5 is in contact with the first surface 41 of the battery element 4. The positive electrode terminal 5 covers the first surface 41 of the battery element 4. A part of the positive electrode terminal 5 may extend around to a surface adjacent to the first surface 41 (for example, the upper and lower surfaces of the battery element 4 in FIG. 1). The positive electrode terminal 5 is responsible for electrical conduction between the battery element 4 and the pad 22.

FIG. 4 is an enlarged cross-sectional view of a part of the electronic device according to the first embodiment. FIG. 4 is an enlarged view of the vicinity of the contact point between the positive electrode terminal 5 and the connection portion 23. The positive electrode terminal 5 includes, for example, a main portion 51 and a coating layer 52.

The main portion 51 is a part in contact with the first surface 41 of the battery element 4. The main portion 51 is in contact with the positive electrode 1 of the battery element 4. The main portion 51 includes, for example, the same material as that contained in the positive electrode 1.

The coating layer 52 covers, for example, the surface of the main portion 51 near the connection portion 23. By forming the coating layer 52 in the positive electrode terminal 5, the thickness of the negative electrode terminal 6 having the coating layer 62 and the thickness of the positive electrode terminal 5 can be made approximately equal. When the thickness of the negative electrode terminal 6 and the positive electrode terminal 5 are approximately equal, tilting of the battery element 4 can be suppressed. The coating layer 52 includes, for example, at least one selected from the group consisting of W, Ti, Ni, Cr, Mn, Fe, Cu, and Co.

### “Method of Manufacturing Electronic Device”

Next, a method of manufacturing the electronic device 100 will be described. First, the battery element 4 is fabricated. The battery element 4 is fabricated, for example, by a co-firing method or a sequential firing method.

The co-firing method is a method of fabricating the battery element 4 by laminating materials forming each layer and then performing single firing. The sequential firing method is a method of performing firing for each layer as it is formed. The co-firing method can fabricate the battery element 4 with fewer process steps than the sequential firing method. In addition, the battery element 4 fabricated by the co-firing method is denser than the battery element 4 fabricated using the sequential firing method. Hereinafter, the case of using the co-firing method will be explained as an example.

First, the materials of the positive electrode current collector layer 1A, the positive electrode active material layer 1i, the solid electrolyte layer 3, the negative electrode active material layer 2B, and the negative electrode current collector layer 2A, which constitute the battery element 4, are made into a paste. The method of making each material into a paste is not particularly limited, and, for example, a method of obtaining a paste by mixing a powder of each material with a vehicle is used. Here, a vehicle is a general term for a medium in a liquid phase. The vehicle includes a solvent or a binder.

Next, green sheets are fabricated. The green sheets are obtained by applying the paste prepared for each material onto a substrate such as a polyethylene terephthalate (PET) film, drying it as necessary, and then peeling off the substrate. The method of applying the paste is not particularly limited, and, for example, known methods such as screen printing, coating, transfer, or doctor blade can be used.

Next, the green sheets prepared for each material are laminated in a desired order and number of layers to fabricate a laminated sheet. When laminating the green sheets, alignment, cutting, or the like is performed as necessary. For example, in the case of fabricating a parallel-type or series-parallel-type battery, alignment is performed so that the end face of the positive electrode current collector layer 1A and the end face of the negative electrode current collector layer 2A do not coincide, and the respective green sheets are laminated.

The laminated sheet may be fabricated by producing a positive electrode unit and a negative electrode unit and then laminating these units. The positive electrode unit is a laminated sheet in which the solid electrolyte layer 3, the positive electrode active material layer 1B, the positive electrode current collector layer 1A, and the positive electrode active material layer 1B are laminated in this order. The negative electrode unit is a laminated sheet in which the solid electrolyte layer 3, the negative electrode active material layer 2B, the negative electrode current collector layer 2A, and the negative electrode active material layer 2B are laminated in this order. The laminating is performed such that the solid electrolyte layer 3 of the positive electrode unit faces the negative electrode active material layer 2B of the negative electrode unit, or such that the positive electrode active material layer 1B of the positive electrode unit faces the solid electrolyte layer 3 of the negative electrode unit.

Next, the fabricated laminated sheet is pressed together to enhance the adhesion of each layer. The pressing can be performed, for example, using a mold press, a warm isostatic press (WIP), a cold isostatic press (CIP), or a hydrostatic press. The pressing is preferably performed while heating. The heating temperature during pressing is, for example, 40 to 95° C. Subsequently, the pressed laminated body is cut using a dicing device to form chips. Then, by performing debinding treatment and firing on the chips, a battery element 4 made of a sintered body is obtained.

The debinding treatment can be performed as a separate step from the firing process. By performing the debinding process, the binder components contained within the chips are thermally decomposed before the firing process, thereby enabling the suppression of the rapid decomposition of the binder components during the firing process. The debinding process is performed, for example, by heating at a temperature of 300 to 800° C. for 0.1 to 10 hours in an air atmosphere. The atmosphere of the debinding process is an oxygen partial pressure environment where the materials constituting the positive electrode, negative electrode, and solid electrolyte do not undergo redox reactions or are less likely to do so, and the gas species can be arbitrarily selected to prevent reactions between the materials constituting the positive electrode, negative electrode, and solid electrolyte and the atmospheric gas. For example, it may be carried out in a nitrogen atmosphere, an argon atmosphere, a nitrogen-hydrogen mixed atmosphere, a steam atmosphere, or a mixture of these atmospheres.

The firing process is performed, for example, by placing the chips on a ceramic base. The firing is performed, for example, by heating to 600 to 1000° C. in a nitrogen atmosphere. The firing time is, for example, 0.1 to 3 hours. The atmosphere of the sintering process is an oxygen partial pressure environment where the materials constituting the positive electrode, negative electrode, and solid electrolyte do not undergo redox reactions or are less likely to do so, and the gas species can be arbitrarily selected to prevent reactions between the materials constituting the positive electrode, negative electrode, and solid electrolyte and the atmospheric gas. For example, it may be carried out in a nitrogen atmosphere, an argon atmosphere, a nitrogen-hydrogen mixed atmosphere, a steam atmosphere, or a mixture of these atmospheres.

In addition, the sintered battery element 4 may be placed in a cylindrical container together with an abrasive material such as alumina and subjected to barrel polishing. This allows the corners of the laminated body to be chamfered. The polishing may also be performed using sandblasting. Sandblasting is preferable because it can remove only specific portions.

The positive electrode terminal 5 is formed on the first surface 41 of the fabricated battery element 4, and the negative electrode terminal 6 is formed on the second surface 42. The positive electrode terminal 5 and the negative electrode terminal 6 can be formed using means such as a sputtering method, a dipping method, screen printing method, or spray coating method. The positive electrode terminal 5 can be formed by laminating the main portion 51 and the coating layer 52 in two separate steps. The negative electrode terminal 6 can be formed by laminating the main portion 61 and the coating layer 62 in two separate steps. By undergoing the above processes, the all-solid-state battery 10 can be fabricated. When forming the positive electrode terminal 5 and the negative electrode terminal 6 only in specific portions, masking with tape or the like is performed, followed by the above-described treatment.

Then, the fabricated all-solid-state battery 10 is mounted on the printed circuit board 20. For example, solder is formed as a connection portion 23 on each of the two pads 22 of the printed circuit board 20, the positive electrode terminal 5 is connected to one pad 22, and the negative electrode terminal 6 is connected to the other pad 22.

The all-solid-state battery according to the present embodiment has the coating layer 62, which does not form an alloy with Li, on the mounting surface 63 of the negative electrode terminal 6. Therefore, even if lithium ions move through the negative electrode 2 and the negative electrode terminal 6, the precipitation of lithium compounds on the mounting surface 63 can be suppressed. As a result, the all-solid-state battery according to the present embodiment is less prone to connection defects between the negative electrode terminal 6 and the connection portion 23.

The embodiment of the present invention has been described in detail above with reference to the drawings. However, each configuration and combination of each embodiment is merely an example, and addition, omission, replacement, and other modifications of the configuration can be made within the scope not departing from the gist of the present invention.

### EXAMPLES

### Example 1

### (Fabrication of Positive Electrode Paste)

For the fabrication of a positive electrode current collector layer paste, a powder obtained by mixing Ag and LiMn₂O₄ at a mass ratio of 80:20 was used. Ethyl cellulose and dihydroterpineol were added to this powder and mixed. Ethyl cellulose serves as a binder, and dihydroterpineol serves as a solvent.

A positive electrode active material layer paste was fabricated by adding ethyl cellulose and dihydroterpineol to LiMn₂O₄ and mixing. LiMn₂O₄ is the positive electrode active material.

(Fabrication of Solid Electrolyte Layer Paste) Li₂CO₃, SiO₂, and Li₃PO₄ were used as starting materials, and these were mixed at a molar ratio of 2:1:1. Using water as a dispersion medium, wet mixing was performed with a ball mill for 16 hours. The mixed material was calcined at 950° C. for 2 hours to fabricate Li_{3.5}Si_{0.5}P_{0.5}O₄. Then, 100 parts by mass of this calcined powder, 100 parts by mass of ethanol, and 200 parts by mass of toluene were added to the ball mill for wet mixing. Furthermore, 16 parts of a polyvinyl butyral-based binder and 4.8 parts by mass of benzyl butyl phthalate were added and mixed to fabricate a solid electrolyte layer paste.

### (Fabrication of Negative Electrode Paste)

For the fabrication of a negative electrode paste, an AgPd alloy was used. Ethyl cellulose and dihydroterpineol were added to this powder and mixed to fabricate a negative electrode paste.

(Fabrication of all-Solid-State Battery)

Next, a positive electrode unit and a negative electrode unit were produced using the following procedure. First, the positive electrode active material layer paste was printed with a thickness of 5 μm on the above-described solid electrolyte layer sheet using screen printing. Next, the printed positive electrode active material layer paste was dried at 80° C. for 5 minutes. Then, the positive electrode current collector layer paste was printed with a thickness of 5 μm on the dried positive electrode active material layer paste using screen printing. Next, the printed positive electrode current collector layer paste was dried at 80° C. for 5 minutes. Then, the positive electrode active material layer paste was printed again with a thickness of 5 μm on the dried positive electrode current collector layer paste using screen printing and dried. After that, the PET film was peeled off. In this manner, a positive electrode unit was obtained, in which the positive electrode active material layer, the positive electrode current collector layer, and the positive electrode active material layer were laminated in this order on the main surface of the solid electrolyte layer.

In addition, a negative electrode unit was obtained, in which a negative electrode was laminated on the main surface of the solid electrolyte layer using a similar procedure. The negative electrode in Example 1 is not separated into a negative electrode current collector layer and a negative electrode active material layer, and AgPd serves both functions of a negative electrode active material and a negative electrode current collector.

Next, a solid electrolyte unit was fabricated by laminating five solid electrolyte layer sheets. The laminated body was fabricated by alternately laminating 50 electrode units (25 positive electrode units and 25 negative electrode units) with the solid electrolyte unit interposed. At this time, the units were laminated with an offset so that the current collector layer of the odd-numbered electrode units extended only to one end face, and the current collector layer of the even-numbered electrode units extended only to the opposite end face. Six solid electrolyte layer sheets were then laminated on top of these laminated units. After that, this was molded by thermocompression bonding and then cut to fabricate a laminated chip. Subsequently, the laminated chip was co-fired to obtain a laminated body. The co-firing was performed by raising the temperature to a firing temperature of 800° C. at a heating rate of 200° C. per hour in a nitrogen atmosphere, holding that temperature for 2 hours, and naturally cooling after firing.

The fabricated laminated body (battery element 4) was then provided with the positive electrode terminal 5 and the negative electrode terminal 6, respectively. For the positive electrode terminal 5, the main portion 51 was made of an AgPd alloy, and the coating layer 52 was made of Fe. For the negative electrode terminal 6, the main portion 61 was made of an AgPd alloy, and the coating layer 62 was made of Fe. The coating layer 62 of the negative electrode terminal 6 was formed so as to cover the first end E1 of the main portion 61. The coating layer 62 covered 80% of the main portion 61. That is, the area of the portion of the surface of the main portion 61 covered by the coating layer 62 was 80% of the surface area of the main portion 61. The average thickness of the main portion 61 was 30 μm, and the average thickness of the coating layer 62 was 3 μm.

Twenty-two all-solid-state batteries 10 were fabricated under the same conditions. Each of the fabricated all-solid-state batteries 10 was then mounted on the printed circuit board 20. Each of the all-solid-state batteries 10 was subjected to 500 charge-discharge cycles. One charge-discharge cycle of the all-solid-state battery 10 was defined as performing constant current charging (CC charging) at a constant current of 0.2 C rate until the battery voltage reached 4.0 V in an environment of 25° C., followed by discharging (CC discharging) at a constant current of 0.2 C rate until the battery voltage reached 0 V.

The bonding between the all-solid-state battery 10 and the printed circuit board 20 after 500 charge-discharge cycles was evaluated. The bonding evaluation was conducted by measuring the fixed joint strength value based on the lateral push shear strength test method of “JIS C 62137-1-2 Annex A,” and samples with a fixed joint strength value below half the average value of samples before the charge-discharge cycles were considered defective. The ratio of the number of defective samples to the number of measured samples was defined as the defect rate. The defect rate in Example 1 was less than 5% (<5%).

### Examples 2 to 8

Examples 2 to 8 differ from Example 1 in that the materials of the coating layer 52 of the positive electrode terminal 5 and the coating layer 62 of the negative electrode terminal 6 were changed. The other conditions were the same as those in Example 1, and the defect rate was determined.
Material of coating layer in Example 2: Mn
Material of coating layer in Example 3: Co
Material of coating layer in Example 4: Cu
Material of coating layer in Example 5: Ni
Material of coating layer in Example 6: Cr
Material of coating layer in Example 7: W
Material of coating layer in Example 8: Ti

### Examples 9 and 10

Examples 9 and 10 differ from Example 1 in that the configuration of the negative electrode was changed. In Example 9, the negative electrode active material was Si. In Example 10, the negative electrode active material was lithium titanate (Li₄Ti₅O₁₂), and the negative electrode current collector was Pt. The other conditions were the same as those in Example 1, and the defect rate was determined.

### Examples 11 to 14

Examples 11 to 14 differ from Examples 1, 4, 5, and 7, respectively, in that the constituent material of the main portion 61 of the negative electrode terminal 6 was changed to Ag. The other conditions were the same as those in Examples 1, 4, 5, and 7, respectively, and the defect rate was determined.

### Examples 15 and 16

Examples 15 and 16 differ from Examples 1 and 4, respectively, in that the negative electrode active material was lithium titanate (Li₄Ti₅O₁₂), the negative electrode current collector was Ag, and the main portion 61 of the negative electrode terminal 6 was changed to Ag. The other conditions were the same as those in Examples 1 and 4, respectively, and the defect rate was determined.

### Examples 17 to 20

Examples 17 to 20 differ from Examples 1, 4, 5, and 7, respectively, in that the negative electrode active material and the negative electrode current collector were Ag. The other conditions were the same as those in Example 1, and the defect rate was determined.

### Examples 21 and 22

Examples 21 and 22 differ from Example 1 in that the coverage rate of the coating layer 62 relative to the main portion 61 was changed. The other conditions were the same as those in Example 1, and the defect rate was determined.

### Example 23

Example 23 differs from Example 1 in that the coating layer 62 of the negative electrode terminal 6 does not cover the first end E1 of the main portion 61. The other conditions were the same as those in Example 1, and the defect rate was determined.

### Examples 24 to 27

Examples 24 to 27 differ from Example 1 in that the thickness and coverage rate of the coating layer 62 of the negative electrode terminal 6 and the coating layer 52 of the positive electrode terminal 5 were changed. The other conditions were the same as those in Example 1, and the defect rate was determined.

### Examples 28 to 54

Examples 28 to 54 differ from Examples 1 to 27, respectively, in that the positive electrode active material was LCO and the positive electrode current collector was Ag/LCO. The other conditions were the same as those in Example 1, and the defect rate was determined.

### Comparative Examples 1 to 8

Comparative Examples 1 to 8 differ from Examples 1, 11, 15, 17, 28, 38, 42, and 44, respectively, in that no coating layer was formed on the positive electrode terminal 5 and the negative electrode terminal 6. The other conditions were the same as those in Example 1.

The results of Examples 1 to 54 and Comparative Examples 1 to 8 are summarized in the following Tables 1 to 4.

TABLE 1

| | | | | | | | | Negative | | |
|---|---|---|---|---|---|---|---|---|---|---|
| | Positive | Positive | Negative | Negative | | | | electrode | | |
| | electrode | electrode | electrode | electrode | Negative | | Thickness | terminal end | | |
| | active | current | active | current | electrode | Coating | of coating | portion | Coverage | Defect |
| | material | collector | material | collector | terminal | layer | layer | coating | rate | rate |
| Example | LMO | Ag/LMO | Ag/Pd | | Ag/Pd | Fe | 3 μm | Coated | 80% | <5% |
| 1 | | | | | | | | | | |
| Example | LMO | Ag/LMO | Ag/Pd | | Ag/Pd | Mn | 3 μm | Coated | 80% | <5% |
| 2 | | | | | | | | | | |
| Example | LMO | Ag/LMO | Ag/Pd | | Ag/Pd | Co | 3 μm | Coated | 80% | <5% |
| 3 | | | | | | | | | | |
| Example | LMO | Ag/LMO | Ag/Pd | | Ag/Pd | Cu | 3 μm | Coated | 80% | <5% |
| 4 | | | | | | | | | | |
| Example | LMO | Ag/LMO | Ag/Pd | | Ag/Pd | Ni | 3 μm | Coated | 80% | <5% |
| 5 | | | | | | | | | | |
| Example | LMO | Ag/LMO | Ag/Pd | | Ag/Pd | Cr | 3 μm | Coated | 80% | <5% |
| 6 | | | | | | | | | | |
| Example | LMO | Ag/LMO | Ag/Pd | | Ag/Pd | W | 3 μm | Coated | 80% | <5% |
| 7 | | | | | | | | | | |
| Example | LMO | Ag/LMO | Ag/Pd | | Ag/Pd | Ti | 3 μm | Coated | 80% | <5% |
| 8 | | | | | | | | | | |
| Example | LMO | Ag/LMO | Si | | Ag/Pd | Fe | 3 μm | Coated | 80% | <5% |
| 9 | | | | | | | | | | |
| Example | LMO | Ag/LMO | LTO | Pt | Ag/Pd | Fe | 3 μm | Coated | 80% | <5% |
| 10 | | | | | | | | | | |
| Example | LMO | Ag/LMO | Ag/Pd | | Ag | Fe | 3 μm | Coated | 80% | <5% |
| 11 | | | | | | | | | | |
| Example | LMO | Ag/LMO | Ag/Pd | | Ag | Cu | 3 μm | Coated | 80% | <5% |
| 12 | | | | | | | | | | |
| Example | LMO | Ag/LMO | Ag/Pd | | Ag | Ni | 3 μm | Coated | 80% | <5% |
| 13 | | | | | | | | | | |
| Example | LMO | Ag/LMO | Ag/Pd | | Ag | W | 3 μm | Coated | 80% | <5% |
| 14 | | | | | | | | | | |
| Example | LMO | Ag/LMO | LTO | Ag | Ag | Fe | 3 μm | Coated | 80% | <5% |
| 15 | | | | | | | | | | |
| Example | LMO | Ag/LMO | LTO | Ag | Ag | Cu | 3 μm | Coated | 80% | <5% |
| 16 | | | | | | | | | | |

TABLE 2

| | | | | | | | | Negative | | |
|---|---|---|---|---|---|---|---|---|---|---|
| | Positive | Positive | Negative | Negative | | | | electrode | | |
| | electrode | electrode | electrode | electrode | Negative | | Thickness | terminal end | | |
| | active | current | active | current | electrode | Coating | of coating | portion | Coverage | Defect |
| | material | collector | material | collector | terminal | layer | layer | coating | rate | rate |
| Example | LMO | Ag/LMO | Ag | | Ag | Fe | 3 μm | Coated | 80% | <5% |
| 17 | | | | | | | | | | |
| Example | LMO | Ag/LMO | Ag | | Ag | Cu | 3 μm | Coated | 80% | <5% |
| 18 | | | | | | | | | | |
| Example | LMO | Ag/LMO | Ag | | Ag | Ni | 3 μm | Coated | 80% | <5% |
| 19 | | | | | | | | | | |
| Example | LMO | Ag/LMO | Ag | | Ag | W | 3 μm | Coated | 80% | <5% |
| 20 | | | | | | | | | | |
| Example | LMO | Ag/LMO | Ag/Pd | | Ag/Pd | Fe | 3 μm | Coated | 75% | <5% |
| 21 | | | | | | | | | | |
| Example | LMO | Ag/LMO | Ag/Pd | | Ag/Pd | Fe | 3 μm | Coated | 70% | 9% |
| 22 | | | | | | | | | | |
| Example | LMO | Ag/LMO | Ag/Pd | | Ag/Pd | Fe | 3 μm | Not coated | 80% | 5% |
| 23 | | | | | | | | | | |
| Example | LMO | Ag/LMO | Ag/Pd | | Ag/Pd | Fe | 0.05 μm | Coated | 75% | 9% |
| 24 | | | | | | | | | | |
| Example | LMO | Ag/LMO | Ag/Pd | | Ag/Pd | Fe | 0.15 μm | Coated | 75% | 5% |
| 25 | | | | | | | | | | |
| Example | LMO | Ag/LMO | Ag/Pd | | Ag/Pd | Fe | 5 μm | Coated | 75% | <5% |
| 26 | | | | | | | | | | |
| Example | LMO | Ag/LMO | Ag/Pd | | Ag/Pd | Fe | 10 μm | Coated | 75% | <5% |
| 27 | | | | | | | | | | |
| Example | LCO | Ag/LCO | Ag/Pd | | Ag/Pd | Fe | 3 μm | Coated | 80% | <5% |
| 28 | | | | | | | | | | |
| Example | LCO | Ag/LMO | Ag/Pd | | Ag/Pd | Mn | 3 μm | Coated | 80% | <5% |
| 29 | | | | | | | | | | |
| Example | LCO | Ag/LMO | Ag/Pd | | Ag/Pd | Co | 3 μm | Coated | 80% | <5% |
| 30 | | | | | | | | | | |
| Example | LCO | Ag/LMO | Ag/Pd | | Ag/Pd | Cu | 3 μm | Coated | 80% | <5% |
| 31 | | | | | | | | | | |
| Example | LCO | Ag/LMO | Ag/Pd | | Ag/Pd | Ni | 3 μm | Coated | 80% | <5% |
| 32 | | | | | | | | | | |

TABLE 3

| | | | | | | | | Negative | | |
|---|---|---|---|---|---|---|---|---|---|---|
| | Positive | Positive | Negative | Negative | | | | electrode | | |
| | electrode | electrode | electrode | electrode | Negative | | Thickness | terminal end | | |
| | active | current | active | current | electrode | Coating | of coating | portion | Coverage | Defect |
| | material | collector | material | collector | terminal | layer | layer | coating | rate | rate |
| Example | LCO | Ag/LCO | Ag/Pd | | Ag/Pd | Cr | 3 μm | Coated | 80% | <5% |
| 33 | | | | | | | | | | |
| Example | LCO | Ag/LCO | Ag/Pd | | Ag/Pd | W | 3 μm | Coated | 80% | <5% |
| 34 | | | | | | | | | | |
| Example | LCO | Ag/LCO | Ag/Pd | | Ag/Pd | Ti | 3 μm | Coated | 80% | <5% |
| 35 | | | | | | | | | | |
| Example | LCO | Ag/LCO | Si | | Ag/Pd | Fe | 3 μm | Coated | 80% | <5% |
| 36 | | | | | | | | | | |
| Example | LCO | Ag/LCO | LTO | Pt | Ag/Pd | Fe | 3 μm | Coated | 80% | <5% |
| 37 | | | | | | | | | | |
| Example | LCO | Ag/LCO | Ag/Pd | | Ag | Fe | 3 μm | Coated | 80% | <5% |
| 38 | | | | | | | | | | |
| Example | LCO | Ag/LCO | Ag/Pd | | Ag | Cu | 3 μm | Coated | 80% | <5% |
| 39 | | | | | | | | | | |
| Example | LCO | Ag/LCO | Ag/Pd | | Ag | Ni | 3 μm | Coated | 80% | <5% |
| 40 | | | | | | | | | | |
| Example | LCO | Ag/LCO | Ag/Pd | | Ag | W | 3 μm | Coated | 80% | <5% |
| 41 | | | | | | | | | | |
| Example | LCO | Ag/LCO | LTO | Ag | Ag | Fe | 3 μm | Coated | 80% | <5% |
| 42 | | | | | | | | | | |
| Example | LCO | Ag/LCO | LTO | Ag | Ag | Cu | 3 μm | Coated | 80% | <5% |
| 43 | | | | | | | | | | |
| Example | LCO | Ag/LCO | Ag | | Ag | Fe | 3 μm | Coated | 80% | <5% |
| 44 | | | | | | | | | | |
| Example | LCO | Ag/LCO | Ag | | Ag | Cu | 3 μm | Coated | 80% | <5% |
| 45 | | | | | | | | | | |

| | | | | | | | | | |
|---|---|---|---|---|---|---|---|---|---|
| Example | LCO | Ag/LCO | Ag | Ag | Ni | 3 μm | Coated | 80% | <5% |
| 46 | | | | | | | | | |
| Example | LCO | Ag/LCO | Ag | Ag | W | 3 μm | Coated | 80% | <5% |
| 47 | | | | | | | | | |
| Example | LCO | Ag/LCO | Ag/Pd | Ag/Pd | Fe | 3 μm | Coated | 75% | <5% |
| 48 | | | | | | | | | |

TABLE 4

| | | | | | | | | Negative | | |
|---|---|---|---|---|---|---|---|---|---|---|
| | Positive | Positive | Negative | Negative | | | | electrode | | |
| | electrode | electrode | electrode | electrode | Negative | | Thickness | terminal | | |
| | active | current | active | current | electrode | Coating | of coating | end portion | Coverage | Defect |
| | material | collector | material | collector | terminal | layer | layer | coating | rate | rate |
| Example 49 | LCO | Ag/LCO | Ag/Pd | | Ag/Pd | Fe | 3 μm | Coated | 70% | 9% |
| Example 50 | LCO | Ag/LCO | Ag/Pd | | Ag/Pd | Fe | 3 μm | Not coated | 80% | 5% |
| Example 51 | LCO | Ag/LCO | Ag/Pd | | Ag/Pd | Fe | 0.05 μm | Coated | 75% | 9% |
| Example 52 | LCO | Ag/LCO | Ag/Pd | | Ag/Pd | Fe | 0.15 μm | Coated | 75% | 5% |
| Example 53 | LCO | Ag/LCO | Ag/Pd | | Ag/Pd | Fe | 5 μm | Coated | 75% | <5% |
| Example 54 | LCO | Ag/LCO | Ag/Pd | | Ag/Pd | Fe | 10 μm | Coated | 75% | <5% |
| Comparative | LMO | Ag/LMO | Ag/Pd | | Ag/Pd | — | — | Not coated | — | 14% |
| Example 1 | | | | | | | | | | |
| Comparative | LMO | Ag/LMO | Ag/Pd | | Ag | — | — | Not coated | — | 14% |
| Example 2 | | | | | | | | | | |
| Comparative | LMO | Ag/LMO | LTO | Ag | Ag | — | — | Not coated | — | 14% |
| Example 3 | | | | | | | | | | |
| Comparative | LMO | Ag/LMO | Ag | | Ag | — | — | Not coated | — | 14% |
| Example 4 | | | | | | | | | | |
| Comparative | LCC | Ag/LCO | Ag/Pd | | Ag/Pd | — | — | Not coated | — | 14% |
| Example 5 | | | | | | | | | | |
| Comparative | LCC | Ag/LCO | Ag/Pd | | Ag | — | — | Not coated | — | 14% |
| Example 6 | | | | | | | | | | |
| Comparative | LCO | Ag/LCO | LTO | Ag | Ag | — | — | Not coated | — | 14% |
| Example 7 | | | | | | | | | | |
| Comparative | LCO | Ag/LCO | Ag | | Ag | — | — | Not coated | — | 14% |
| Example 8 | | | | | | | | | | |

As shown in Tables 1 to 4, Examples 1 to 54, in which the negative electrode terminal 6 has the coating layer 62, exhibited a lower defect rate compared to Comparative Examples 1 to 8, which do not have the coating layer 62. This is considered to be due to the coating layer 62 suppressing the precipitation of lithium compounds on the mounting surface 63.

### INDUSTRIAL APPLICABILITY

According to the present invention, it is possible to provide an all-solid-state battery that is less prone to mounting defects.

### REFERENCE SIGNS LIST

1 Positive electrode
1A Positive electrode current collector layer
1B Positive electrode active material layer
2 Negative electrode
2A Negative electrode current collector layer
2B Negative electrode active material layer
3 Solid electrolyte layer
4 Battery element
5 Positive electrode terminal
6 Negative electrode terminal
10 All-solid-state battery
20 Printed circuit board
21 Substrate
22 Pad
23 Connection portion
41 First surface
42 Second surface
51, 61 Main portion
52, 62 Coating layer
63 Mounting surface

1. An all-solid-state battery comprising:
a battery element having a positive electrode, a negative electrode, and a solid electrolyte layer between the positive electrode and the negative electrode;
a positive electrode terminal connected to the positive electrode on a first surface of the battery element; and
a negative electrode terminal connected to the negative electrode on a second surface different from the first surface of the battery element,
wherein the negative electrode includes a material that forms an alloy with Li,
wherein the negative electrode terminal has a main portion including a material that forms an alloy with Li and a coating layer covering at least a part of an outer surface of the main portion,
wherein at least a part of a mounting surface of the negative electrode terminal is the coating layer, and
wherein the coating layer includes at least one selected from the group consisting of W, Ti, Ni, Cr, Mn, Fe, Cu, and Co.

2. The all-solid-state battery according to claim 1,
wherein the entire mounting surface of the negative electrode terminal is the coating layer.

3. The all-solid-state battery according to claim 1,
wherein a first end of the main portion on a side closer to the mounting surface is covered by the coating layer.

4. The all-solid-state battery according to claim 1,
wherein the coating layer covers 75% or more of the outer surface of the main portion.

5. The all-solid-state battery according to claim 1,
wherein an average thickness of the coating layer is 0.1 μm to 100 μm.

6. The all-solid-state battery according to claim 1,
wherein an average thickness of the coating layer is thinner than an average thickness of the main portion.

7. The all-solid-state battery according to claim 1,
wherein the positive electrode terminal includes a main portion connected to the positive electrode and a coating layer covering at least a part of an outer surface of the main portion of the positive electrode terminal and including at least one selected from the group consisting of W, Ti, Ni, Cr, Mn, Fe, Cu, and Co.

8. The all-solid-state battery according to claim 1,
wherein the negative electrode and the negative electrode terminal include Ag.

9. An electronic device on which the all-solid-state battery according to claim 1 is mounted.
